(19) United States
(12) Patent Application Publication
(10) Pub. No.: US 2010/0168301 A1
(43) Pub. Date: Jul. 1, 2010

(54) AQUEOUS FLUORINE-CONTAINING POLYMER DISPERSION AND METHOD FOR PRODUCTION THEREOF

(75) Inventors: Chie Sawauchi, Osaka (JP); Nobuhiko Tsuda, Osaka (JP)

Correspondence Address: SUGHRUE MION, PLLC, 2100 PENNSYLVANIA AVENUE, N.W., SUITE 800, WASHINGTON, DC, 20037, US

(73) Assignee: DAIKIN INDUSTRIES, LTD., Osaka-shi, Osaka (JP)

(21) Appl. No.: 11/993,564

(22) PCT Filed: Jun. 23, 2006
(86) PCT No.: PCT/JP2006/312648

§ 371 Date: Dec. 21, 2007

(30) Foreign Application Priority Data
Jun. 24, 2005 (JP) 2005-185753

(51) Int. Cl. C08K 5/17; C08J 3/05

(52) U.S. Cl. 524/186; 524/80

(57) ABSTRACT

It is an object of the present invention to provide an aqueous fluoropolymer dispersion which will not send out any amine-like odor in spite of its having been brought into contact with an anion exchange resin as well as a method of producing the same.

This invention is related to an aqueous fluoropolymer dispersion containing a nitrogen-containing organic base and/or a salt thereof, together with a particle of fluoropolymer dispersed therein wherein said nitrogen-containing organic base and/or the salt thereof amounts, in total, to 0 to 1 ppm of said aqueous fluoropolymer dispersion.

### TECHNICAL FIELD

The present invention relates to an aqueous fluoropolymer dispersion and a process for producing the same.

### BACKGROUND ART

Aqueous fluoropolymer dispersions, when applied by such a method as coating or impregnation, can form films, coating films and the like excellent in such characteristics as chemical stability, nonstickiness and weather resistance. Therefore, they are widely used in such fields of application as lining of cooking utensils and pipes or tubes and manufacture of impregnated glass cloth membranes. Aqueous fluoropolymer dispersions are generally obtained by polymerization in the presence of a fluorinated surfactant. Since, however, such a fluorinated surfactant is a factor causing deteriorations in those excellent characteristics of fluoropolymers, it is desirable to eliminate the same from the aqueous fluoropolymer dispersions. In addition, the fluorinated surfactant is generally expensive, so that it is preferable to recover the same for reuse.

As a method of recovering such fluorinated surfactant, the method which comprises brining an aqueous fluoropolymer dispersion, with a nonionic emulsifier added for the purpose of stabilization, into contact with a basic anion exchange resin has been proposed (cf. e.g. Patent Document 1). However, this document gives no description of the fact that the aqueous fluoropolymer dispersion gives out an amine-like odor upon contact with a basic anion exchange resin.
Patent Document 1: Japanese Kohyo Publication 2002-532583

### DISCLOSURE OF INVENTION

### Problems which the Invention is to Solve

In view of the above-discussed state of the art, it is an object of the present invention to provide an aqueous fluoropolymer dispersion which will not send out any amine-like odor in spite of its having been brought into contact with an anion exchange resin as well as a method of producing the same.

### Means for Solving the Problems

This invention is related to an aqueous fluoropolymer dispersion containing a nitrogen-containing organic base and/or a salt thereof, together with a particle of fluoropolymer dispersed therein wherein said nitrogen-containing organic base and/or the salt thereof amounts, in total, to 0 to 1 ppm of said aqueous fluoropolymer dispersion (hereinafter, such an aqueous fluoropolymer dispersion is sometimes referred to as “aqueous fluoropolymer dispersion (1) of the present invention”).

This invention is related to an aqueous fluoropolymer dispersion prepared by subjecting a to-be-treated aqueous fluoropolymer dispersion to contact treatment (T1) comprising contact with an anion exchange resin and subsequent contact with active carbon and/or a cation exchange resin, or by subjecting the to-be-treated dispersion to contact treatment (T2) comprising contact with a mixed bed containing an anion exchange resin as well as active carbon and/or a cation exchange resin (hereinafter, such an aqueous fluoropolymer dispersion is sometimes referred to as “aqueous fluoropolymer dispersion (2) of the present invention”).

This invention is related to a method of producing an aqueous fluoropolymer dispersion which comprises subjecting a to-be-treated aqueous fluoropolymer dispersion comprising a particle of fluoropolymer dispersed therein to contact treatment, said contact treatment comprising contact (P) with an anion exchange resin and contact (Q) with active carbon and/or with a cation exchange resin. Hereinafter, the present invention is described in detail.

The aqueous fluoropolymer dispersion (1) of the present invention and the aqueous fluoropolymer dispersion (2) of the present invention (hereinafter, these aqueous fluoropolymer dispersions are sometimes collectively referred to as “aqueous fluoropolymer dispersion of the present invention”) each comprises particles of fluoropolymer dispersed therein. The fluoropolymer, so referred to herein, is not particularly restricted but includes polytetrafluoroethylene [PTFE], tetrafluoroethylene [TFE]/hexafluoropropylene [HFP] copolymers [FEPs], TFE/perfluoro(alkyl vinyl ether) [PAVE] copolymers [PFAs], ethylene/TFE copolymers [ETFEs], polyvinylidene fluoride [PVDF] and polychlorotrifluoroethylene [PCTFE], among others. The above-mentioned PTFE may be a tetrafluoroethylene [TFE] homopolymer or a modified polytetrafluoroethylene [modified PTFE]. The term “modified PTFE” as used herein means a non-melt-processable fluoropolymer obtained by polymerizing TFE and a very small proportion of a monomer. As the monomer to be used in a very small proportion, there may be mentioned, for example, fluoroolefins such as HFP and chlorotrifluoroethylene [CTFE], fluoro(alkyl vinyl ether) species having an alkyl group of 1 to 5, in particular 1 to 3, carbon atoms; fluorodioxoles; perfluoroalkylethylenes; and w-hydroperfluoroolefins.

Preferred as the fluoropolymer are perfluoropolymers; more preferred are TFE homopolymers and modified PTFE species, among others.

The aqueous fluoropolymer dispersion of the present invention generally contains particles of fluoropolymer in an amount of 20 to 75% by mass of the aqueous fluoropolymer dispersion.

When the fluoropolymer concentration is lower than 20% by mass, the economic efficiency in transportation may sometimes be reduced and, at levels exceeding 75% by mass, the stability may sometimes be threatened.

A preferred lower limit to the fluoropolymer concentration is 25% by mass and a preferred upper limit thereto is 70% by mass. The above-mentioned aqueous fluoropolymer dispersion may be a dispersion as obtained by polymerization without concentration or dilution or a dispersion appropriately concentrated or diluted, for instance, to adjust the fluoropolymer concentration so that it may fall within the above range. The fluoropolymer concentration (P), so referred to herein, is determined by weighing about 1 g (X g) of the sample in an aluminum cup with a diameter of 5 cm, heating the sample at 100° C. for 1 hour and then further heating at 300° C. for 1 hour to give a heating residue (Z) and making a calculation as follows: P=(Z/X)×100(%).

The aqueous fluoropolymer dispersion of the present invention generally comprises particles of the above-mentioned fluoropolymer as dispersed in an aqueous medium.

The aqueous medium to be used in the practice of the present invention is not particularly restricted but may be any water-containing liquid. Thus, it may contain, in addition to water, a non-fluorinated organic solvent and/or a fluorinated organic solvent such as an alcohol, ether, ketone or paraffin wax.

The aqueous fluoropolymer dispersion of the present invention generally comprises particles of the above-mentioned fluoropolymer, in the presence of a surfactant, as dispersed in an aqueous medium.

The surfactant is, for example, a fluorinated surfactant or a nonionic surfactant.

The fluorinated surfactant is not particularly restricted but preferably is a fluorinated anionic surfactant; it preferably contains 7 to 10 carbon atoms. More preferably, it is a fluorinated anionic surfactant of 7 to 10 carbon atoms. As the fluorinated anionic surfactant, there maybe mentioned, for example, perfluorooctanoic acid [PFOA], perfluorooctylsulfonic acid [PFOS] and like fluorinated organic acids, or salts thereof.

When the fluorinated anionic surfactant is in the form of a salt, the salt-forming counter ion is, for example, an alkali metal ion or HH₄⁺; the alkali metal ion is, for example, Na⁺ or K⁺. Preferred as the counter ion is NH₄⁺, however.

The aqueous fluoropolymer dispersion of the present invention can contain a fluorinated surfactant preferably in an amount of 100 ppm or less, more preferably 50 ppm or less, still more preferably 30 ppm or less, of the fluoropolymer.

The fluorinated surfactant concentration, so referred to herein, is determined by adding an equal volume of methanol to the aqueous dispersion to be assayed, subjecting the mixture to Soxhlet extraction or centrifugation and subjecting the extract or supernatant to ¹⁹F-NMR measurement.

As the above-mentioned nonionic surfactant, there may be mentioned, for example, ether type nonionic surfactants such as polyoxyethylene alkylphenyl ethers, polyoxyethylene alkyl ethers, polyoxyethylenealkylene alkyl ethers, polyoxyethylene derivatives such as ethylene oxide/propylene oxide block copolymers, ester type nonionic surfactants such as sorbitan fatty acid esters, polyoxyethylenesorbitan fatty acid esters, polyoxyethylenesorbitol fatty acid esters, glycerol fatty acid esters and polyoxyethylene fatty acid esters, and amine type nonionic emulsifiers such as polyoxyethylenealkylamines and alkylalkanolamides. Further, those nonionic surfactants which contain no alkylphenol moiety in their structure can be preferably used.

The above-mentioned aqueous fluoropolymer dispersion may contain the above nonionic surfactant preferably in an amount not exceeding 50 parts by mass, more preferably not exceeding 20 parts by mass, per 100 parts by mass of the fluoropolymer.

The nonionic surfactant content (N), so referred to herein, is determined by weighing about 1 g (X g) of the sample in an aluminum cup with a diameter of 5 cm, heating the sample at 100° C. for 1 hour to give a heating residue (Y g), further heating the heating residue (Y g) at 300° C. for 1 hour to give a heating residue (Z g) and making a calculation according to the equation: N=[(Y−Z)/Z]33 100(%).

The aqueous fluoropolymer dispersion (1) of the present invention may contain a nitrogen-containing organic base and/or a salt thereof.

The nitrogen-containing organic base and/or the salt thereof comprise at least one compound selected from the group consisting of:
(1) Amines represented by the formula NR¹R²R³ (in which R¹, R² and R³ are the same or different and each represents a hydrogen atom, an alkyl group or a hydroxyalkyl group; the case where R¹, R² and R³ each is a hydrogen atom being excluded),
(2) Amine complexes comprising any of the amines mentioned above,
(3) Amine-based oniums represented by the formula ⁺NR¹R²R³R⁴ (in which R¹, R², R³ and R⁴ are the same or different and each represents a hydrogen atom, an alkyl group or a hydroxyalkyl group; the case where R¹, R², R³ and R⁴ each is a hydrogen atom being excluded), and
(4) Amine-based onium compounds comprising any of the amine-based oniums mentioned above, among others.

The substituents R¹, R² and R³ constituting the above-mentioned amines (1) each may be an alkyl group or an hydroxyalkyl group, and R¹, R² and R³ each may be an alkyl group. In the amines (1) mentioned above, the alkyl or hydroxyalkyl group represented by R¹, R² and/or R³ each may contain 1 to 3 carbon atoms or not more than 2 carbon atoms.

As the amine complexes mentioned above under (2), there maybe mentioned complexes of the amines (1) mentioned above with transition metals, for instance.

At least three of the substituents R¹, R², R³ and R⁴ constituting the amine-based oniums mentioned above under (3) each may be an alkyl or hydroxyalkyl group.

In the above amine-based oniums (3), the alkyl or hydroxyalkyl group represented by R¹, R², R³ and R⁴ each may contain 1 to 3 carbon atoms or not more than 2 carbon atoms. Preferred as the above-mentioned nitrogen-containing organic base and/or the salt thereof to be used in the practice of the present invention are, among others, tertiary amines represented by the formula NR¹¹R¹²R¹³ (in which R¹¹, R¹² and R¹³ are the same or different and each represents an alkyl group of 1 or 2 carbon atoms) and/or tertiary amine-based oniums represented by the formula ⁺NR¹¹R¹²R¹³R¹⁴ (in which R¹¹, R¹², R¹³ and R¹⁴ are the same or different and each represents a hydrogen atom or an alkyl group of 1 or 2 carbon atoms provided that at least three of R¹¹, R¹², R¹³ and R¹⁴ each is an alkyl group of 1 or 2 carbon atoms).

The aqueous fluoropolymer dispersion (1) of the present invention contains the above-mentioned nitrogen-containing organic base and/or the salt thereof in a total amount of 0 to 1 ppm, preferably not larger than 0.1 ppm, more preferably not larger than 0.02 ppm; it may be one free of such base or salt. Considering the step of heating, the content thereof is still more preferably not larger than 0.01 ppm.

While the nitrogen-containing organic base and/or salt may become a substance causative of odor emanation, the aqueous fluoropolymer dispersion of the present invention has a content of the base and/or salt mentioned above as falling within the range mentioned above and therefore will never dissipate the amine-like odor.

The nitrogen-containing organic base and/or salt content, so referred to herein, is determined by adding an equal volume of methanol to the aqueous dispersion to be assayed, subjecting the mixture to centrifugation under conditions of a field coefficient of 419G, recovering the supernatant, if necessary concentrating the same, and subjecting the same to capillary electrophoresis.

The aqueous fluoropolymer dispersion (1) of the present invention may be prepared by any method provided that the dispersion contains the nitrogen-containing organic base and/or salt, the fluoropolymer and the aqueous medium within the respective limits mentioned above. The dispersion (1) can be prepared with ease by carrying out the method for preparing the aqueous fluoropolymer dispersion (2) of the present invention, which is to be described later herein, or by carrying out the method of producing an aqueous fluoropolymer dispersion according to the present invention.

The aqueous fluoropolymer dispersion (2) of the present invention is prepared by subjecting a to-be-treated aqueous fluoropolymer dispersion to contact treatment (T1) comprising contact with an anion exchange resin and subsequent contact with active carbon and/or a cation exchange resin, or by subjecting the to-be-treated dispersion to contact treatment (T2) comprising contact with a mixed bed containing an anion exchange resin as well as active carbon and/or a cation exchange resin.

The to-be-treated aqueous fluoropolymer dispersion comprises a particle of fluoropolymer as dispersed therein. The to-be-treated aqueous fluoropolymer dispersion generally has a fluoropolymer content of 20 to 70% by mass, and a preferred lower limit to that content is 25% by mass and a preferred upper limit thereto is 65% by mass.

The to-be-treated aqueous fluoropolymer dispersion can be prepared, for example, by polymerization in the presence of a fluorinated surfactant.

As the fluorinated surfactant, there may be mentioned those enumerated hereinabove and, among them, PFOA, PFOS and the like are preferred.

The fluorinated monomer to be used in the above-mentioned polymerization is not particularly restricted but includes, among others, TFE, HFP, PAVEs, vinylidene fluoride [VDF] and chlorotrifluoroethylene [CTFE]. In that polymerization, a non-fluorinated monomer such as ethylene may also be used in addition to the fluorinated monomer or monomers.

In the practice of the present invention, the polymerization reaction conditions such as temperature, pressure, surfactant concentration and so forth can be properly selected according to the desired fluoropolymer species and the amount thereof, among others.

The above-mentioned to-be-treated aqueous fluoropolymer dispersion may be an aqueous dispersion as just prepared by carrying out the above-mentioned polymerization or an aqueous dispersion obtained by subjecting the above-mentioned aqueous dispersion as just obtained by polymerization to such after-treatment as concentration or dilution.

The after-treatment can be carried out in the conventional manner, for example in the manner of phase separation concentration, ultrafiltration or electroconcentration. As the phase separation method, there may be mentioned, for example, the method described in U.S. Pat. No. 3,037,953. As the ultrafiltration method, there may be mentioned, for example, the method described in Japanese Kokoku Publication Hei-02-34971. As the electroconcentration method, there may be mentioned, for example, the method described in British Patent No. 642,025.

The aqueous fluoropolymer dispersion (2) of the present invention is prepared by subjecting the to-be-treated aqueous fluoropolymer dispersion to the contact treatment (T1) or contact treatment (T2).

The aqueous fluoropolymer dispersion (2) of the present invention can generally be prepared with ease by carrying out the contact treatment (T1) or contact treatment (T2) only once. However, it may be prepared by carrying out either of the contact treatments two or more times or may be prepared by anion exchange resin treatment, followed by the contact treatment (T2). The aqueous fluoropolymer dispersion (2) of the present invention may also be prepared by contact with active carbon and/or contact with a cation exchange resin prior to contact with an anion exchange resin alone or with an anion exchange resin in a mixed bed and, in that case, impurities in the to-be-treated aqueous fluoropolymer dispersion can be removed to a certain extent, so that the overall removal efficiency can be advantageously improved.

The above mentioned contact treatment (T1) and contact treatment (T2) respectively comprise contact (P) with an anion exchange resin (hereinafter, such contact is also referred to as “contact (P) ”) and contact (Q) with active carbon and/or with a cation exchange resin (hereinafter, such contact is also referred to as “contact (Q)”).

As the anion exchange resin to be used in the contact (P), there may be mentioned, for example, strongly basic anion exchange resins having an —N⁺X⁻(CH₃)₃ group (X representing Cl or OH) as a functional group, strongly basic anion exchange resins having an —N⁺X⁻(CH₃)₃(C₂H₄OH) group (X having the same meaning as above) and like ones known in the art.

The above anion exchange resin preferably has a counter ion corresponding to an acid having a pKa value of 3 or higher and is preferably used in the OH⁻form.

The above anion exchange resin is preferably one prepared by treating the Cl form resin with a 1 M aqueous solution of NaOH for conversion to the OH⁻form, followed by thorough washing with pure water.

The contact (P) can be established under appropriate conditions selected according to such a conventional method as described in Japanese Kohyo Publication 2002-532583 and, for example, is preferably made at a space velocity [SV] of 0.1 to 10, preferably 0.5 to 5.

The aqueous dispersion obtained by carrying out the above contact (P) generally contains the above-mentioned nitrogen-containing organic base and/or the salt thereof in an amount of about 2 to 100 ppm of the aqueous dispersion although the fluorinated surfactant level can be reduced to a level within the range given hereinabove. Nevertheless, the nitrogen-containing organic base and/or the salt thereof can be removed from the aqueous dispersion by making the above contact (Q), so that the resulting aqueous fluoropolymer dispersion can have a reduced content of the base and/or the salt thereof.

The base and/or the salt thereof is presumably derived from the anion exchange group in the anion exchange resin used in the contact (P) by cleavage thereof from the polymer main chain constituting the anion exchange resin and, in this respect, the species of the base and/or the salt thereof probably depends on the anion exchange group in the anion exchange resin used.

The contact with active carbon in the above-mentioned contact (Q) can also still further reduce the fluorinated surfactant level in the aqueous dispersion to be treated with fluorinated surfactant concentration being reduced by the above-mentioned contact (P). The contact with active carbon in the contact (Q) will not cause such blocking as clogging possibly encountered on the occasion of contact with an ultrafiltration membrane but the active carbon can be used repeatedly in an efficient and economical manner; further, the rate of treatment can be increased.

The contact with active carbon can be made generally within the temperature range of 15 to 50° C.

In the above contact (Q), active carbon is to be used in an effective amount. Although the effective amount may vary depending on the properties and condition of the active carbon species employed and the contact conditions, among others, it is generally preferred that active carbon be used in an amount of 0.1 to 100 parts by mass per 100 parts by mass of the aqueous dispersion to be treated.

A more preferred lower limit to the effective amount of active carbon per 100 parts by mass of the aqueous dispersion to be treated is 1 part by mass, a still more preferred lower limit thereto is 2 parts by mass, and a more preferred upper limit thereto is 50 parts by mass.

The active carbon is preferably one in which minute particles has been removed prior to contact with the aqueous dispersion to be treated. The method of removing minute particles is not particularly restricted but, generally, they can be removed to a satisfactory extent in a simple and easy manner by washing with water.

In the practice of the present invention, active carbon is preferably heated at 100 to 400° C. for about 1 to 24 hours for reactivation and, further following such heat treatment, subjected to such ordinary pretreatment as at least several hours of immersion in water, for example deionized water, for removing air bubbles from pores thereof.

In the practice of the present invention, the contact with active carbon is preferably carried out by a method based on the passage of the aqueous dispersion to be treated through a column packed with active carbon since such method can easily recover the aqueous fluoropolymer dispersion to be obtained. When the contact with active carbon is carried out with such a column, the velocity of the aqueous dispersion to be treated passing through the column can be properly adjusted in the conventional manner of using columns according to the fluoropolymer species, solid content and other factors.

The cation exchange resin to be used in the above contact (Q) includes known in the art, for example strongly acidic cation exchange resins having —SO₃⁻ groups as functional groups and weakly acidic cation exchange resins having —COO⁻ groups as functional groups. In view of their good adsorptivity for the above-mentioned nitrogen-containing organic bases and/or salts thereof, strongly acidic cation exchange resins are preferred among them, and H⁺-form strongly acidic cation exchange resins are more preferred.

The cation exchange resin to be used is preferably one prepared by treating the Na-form resin with 1 M aqueous solution of HCl for conversion to the H+ form, followed by thorough washing with pure water.

For the contact with the above-mentioned cation exchange resin, proper conditions can be selected according to the cation exchange resin species employed and the amount thereof, among others. Preferably, however, the contact is carried out so that the SV (space velocity) may amount to 0.1 to 10.

As the anion exchange resin and the carbon black and/or the cation exchange resin to be used in the above-mentioned contact treatment (T2) according to the present invention, there may be mentioned those enumerated hereinabove.

The preparation of the mixed bed and the selection of treatment conditions in the above contact treatment (T2) can be made in the conventional manner. It is preferred, however, that the contact operation be carried out so that SV may amount to 0.1 to 10, more preferably 0.5 to 5.

The aqueous fluoropolymer dispersion (2) of the present invention may contain the above-mentioned nitrogen-containing organic base and/or the salt thereof.

When the aqueous fluoropolymer dispersion (2) of the present invention contains the above-mentioned nitrogen-containing organic base and/or the salt thereof, the content of the same is preferably within the same range as described above for the aqueous fluoropolymer dispersion (1) of the present invention.

The method of producing the aqueous fluoropolymer dispersion of the present invention comprises subjecting a to-be-treated aqueous fluoropolymer dispersion to contact treatment comprising contact (P) with an anion exchange resin and contact (Q) with active carbon and/or with a cation exchange resin. By carrying out this production method, it becomes possible to readily prepare the above-mentioned aqueous fluoropolymer dispersion of the present invention and like aqueous fluoropolymer dispersions low in the content of a nitrogen-containing organic base and/or a salt thereof.

In carrying out the production method of the present invention, the to-be-treated aqueous fluoropolymer dispersion, the contact (P) with an anion exchange resin and the contact (Q) with active carbon and/or with a cation exchange resin are as described above referring to the aqueous fluoropolymer dispersion of the present invention.

As the contact treatment in the production method of the present invention, there may be mentioned, for example, the above-mentioned contact treatment (T1) and contact treatment (T2), among others. Preferred is the treatment (T1a) comprising contact with an anion exchange resin and the subsequent contact with active carbon or the treatment (T2a) comprising contact with a mixed bed containing an anion exchange resin and active carbon. More preferred is the treatment (T2a) in which the above-mentioned contact (P) and contact (Q) can be carried out simultaneously.

The aqueous fluoropolymer dispersion of the present invention is high in fluoropolymer concentration and low in surfactant content, as mentioned above, and, therefore, when it is used as a material for tubes, films, molded articles and so forth, the thermal stability and other properties of the fluoropolymer are hardly deteriorated. Further, the aqueous fluoropolymer dispersion of the present invention is low in the content of nitrogen-containing organic bases and salts thereof and therefore scarcely emits an odor.

### EFFECTS OF THE INVENTION

The aqueous fluoropolymer dispersion of the present invention, which has the constitution described hereinabove, is low in contents of nitrogen-containing organic base and/or salts thereof and, therefore, are almost odorless and are excellent in workability in processing into films, impregnated articles, coatings, molded articles and the like. Furthermore, the aqueous fluoropolymer dispersion can be adjusted to a high fluoropolymer concentration level and a low surfactant content level and therefore is excellent as a material for films, molded articles and so forth.

In particular, since odor emission therefrom is slight at elevated temperatures, it is especially useful in such fields of application as impregnation, in particular in the fields of batteries and semiconductors where amine type impurities are objects of dislike.

The method of producing an aqueous fluoropolymer dispersion according to the present invention, which has the constitution described hereinabove, can produce the above-mentioned aqueous fluoropolymer dispersion in a simple and easy manner with high efficiency.

### BEST MODES FOR CARRYING OUT THE INVENTION

The following examples illustrate the present invention in further detail. These examples are, however, by no means limitative of the present invention.

In the examples, “part(s)” means “part(s) by mass”, unless otherwise specified.

The measurements made in the examples were carried out according to the methods described below.

### 1. Fluoropolymer Concentration (P)

About 1 g (X) of each sample was weighed in an aluminum cup with a diameter of 5 cm. The sample was dried at 100° C. for 1 hour and then further dried at 300° C. for 1 hour to give a heating residue (Z) and a calculation was made as follows: P=Z/X×100(%).

### 2. Ammonium Perfluorooctanoate [PFOA] Concentration

An equal volume of methanol was added to each aqueous dispersion obtained, the mixture was subjected to Soxhlet extraction and the extract was subjected to ¹⁹F-NMR (measuring apparatus: AC300P, product of Bruker BioSpin) for concentration determination.

### 3. Nonionic Surfactant Content (N)

About 1 g (X g) of each sample was weighed in an aluminum cup with a diameter of 5 cm, the sample was heated at 100° C. for 1 hour to give a heating residue (Y g), the heating residue (Y g) was further heated at 300° C. for 1 hour to give a heating residue (Z g) and a calculation was made according to the equation: N=[(Y−Z)/Z]×100(%).

4. Contents of Nitrogen-Containing Organic Base and/or Salts Thereof

The contents in question were determined by carrying out capillary electrophoresis under the conditions given below following centrifugation under conditions of a field coefficient of 419 G.

Capillary electrophoresis

Apparatus: 3DCE (Hewlett-Packard)

Capillary column: Fused Silica ø 75 μm×length 56 cm

Buffer: Buffer solution for cation HPCE

Detector: Signals 310 nm/Reference 215 nm

### Example 1

An aqueous fluoropolymer dispersion (400 ml) containing 32% of polytetrafluoroethylene [PTFE] as a fluoropolymer, 6 parts of a nonionic surfactant (TDS80C, product of Daiichi Kogyo Seiyaku) per 100 parts of the fluoropolymer and PFOA in an amount of 3000 ppm of the fluoropolymer was passed through a column (20 mm in diameter) packed with 25 ml of an anion exchange resin (product name: Amberlite IRA900J, product of Rohm and Haas) under conditions of a temperature of 50° C. and a space velocity [SV] of 2 for effecting contact (P) to give a dispersion containing PFOA in an amount of 50 ppm of the fluoropolymer and 2 ppm of trimethylamine relative to the whole amount of the dispersion.

The dispersion obtained was passed through a column (20 mm in diameter) packed with 25 ml of a cation exchange resin (product name: Amberlite IRA120B, product of Rohm and Haas) under conditions of a temperature of 50° C. and a space velocity [SV] of 2 for effecting contact (Q) to give an aqueous fluoropolymer dispersion. In the aqueous fluoropolymer dispersion obtained, a fluoropolymer concentration was 32%, the nonionic surfactant content was 6 parts per 100 parts of the fluoropolymer, PFOA amounted to 50 ppm of the fluoropolymer and trimethylamine amounted to less than 0.001 ppm of the aqueous fluoropolymer dispersion.

### Example 2

An aqueous fluoropolymer dispersion (400 ml) containing 32% of PTFE as a fluoropolymer, 6 parts of a nonionic surfactant (TDS80C, product of Daiichi Kogyo Seiyaku) per 100 parts of the fluoropolymer and PFOA in an amount of 3000 ppm of the fluoropolymer was passed through a column (20 mm in diameter) packed with 25 ml of an anion exchange resin (product name: Amberlite IRA402J, product of Rohm and Haas) under conditions of a temperature of 50° C. and a space velocity [SV] of 2 for effecting contact (P) to give a dispersion containing PFOA in an amount of 45 ppm of the fluoropolymer and 3 ppm of trimethylamine relative to the whole amount of the dispersion. The dispersion obtained was passed through a column (20 mm in diameter) packed with 25 ml of a cation exchange resin (product name: Amberlite IRA120B, product of Rohm and Haas) under conditions of a temperature of 50° C. and a space velocity [SV] of 2 for effecting contact (Q) to give an aqueous fluoropolymer dispersion. In the aqueous fluoropolymer dispersion obtained, a fluoropolymer concentration was 32%, the nonionic surfactant content was 6 parts per 100 parts of the fluoropolymer, an amount of PFOA amounted to 45 ppm of the fluoropolymer and trimethylamine amounted to less than 0.001 ppm of the aqueous fluoropolymer dispersion.

### Example 3

An aqueous fluoropolymer dispersion (400 ml) containing 32% of PTFE as a fluoropolymer, 6 parts of a nonionic surfactant (TDS80C, product of Daiichi Kogyo Seiyaku) per 100 parts of the fluoropolymer and PFOA in an amount of 3000 ppm of the fluoropolymer was passed through a column (20 mm in diameter) packed with 25 ml of an anion exchange resin (product name: Amberlite IRA402J, product of Rohm and Haas) under conditions of a temperature of 50° C. and a space velocity [SV] of 2 for effecting contact (P) to give a dispersion containing PFOA in an amount of 50 ppm of the fluoropolymer and 3 ppm of trimethylamine relative to the whole amount of the dispersion. Separately, active carbon (Zeocoal M-10A, product of Asahirokazai) was heated at 150° C. for 3 hours, immersed in deionized water, allowed to stand for 24 hours and then packed into a column (20 mm in diameter) to a height of 200 mm. Further, this active carbon-packed column was washed by passing deionized water through the same until the washings leaving the column became transparent. An active carbon-packed column was thus prepared.

The dispersion obtained by the above-mentioned contact (P) was passed through the active carbon-packed column prepared in the above manner under conditions of an SV of 2 and a temperature of 25° C. for effecting contact (Q) to give an aqueous fluoropolymer dispersion. In the aqueous fluoropolymer dispersion obtained, a fluoropolymer concentration was 32%, the nonionic surfactant content was 6 parts per 100 parts of the fluoropolymer, an amount of PFOA amounted to 50 ppm of the fluoropolymer and trimethylamine amounted to less than 0.001 ppm of the aqueous fluoropolymer dispersion.

### Example 4

An aqueous fluoropolymer dispersion (400 ml) containing 32% of PTFE as a fluoropolymer, 6 parts of a nonionic surfactant (TDS80C, product of Daiichi Kogyo Seiyaku) per 100 parts of the fluoropolymer and PFOA in an amount of 3000 ppm of the fluoropolymer was passed through a column (20 mm in diameter) packed with 35 ml of a mixed resin composed of an anion exchange resin (product name: Amberlite IRA900J, product of Rohm and Haas) and a cation exchange resin (product name: Amberlite IRA120B, product of Rohm and Haas) in a volume ratio of 2:1 under conditions of a temperature of 50° C. and a space velocity [SV] of 4 for effecting contact (P) and contact (Q) simultaneously to give an aqueous fluoropolymer dispersion. In the aqueous fluoropolymer dispersion obtained, a fluoropolymer concentration was 32%, the nonionic surfactant content was 6 parts per 100 parts of the fluoropolymer, an amount of PFOA amounted to 55 ppm of the fluoropolymer and trimethylamine amounted to less than 0.001 ppm of the aqueous fluoropolymer dispersion.

The results obtained in these examples revealed that while the aqueous dispersion obtained from contact (P) is high in the contents of nitrogen-containing organic base and/or salts, hence outside the scope of the present invention, the content of bases or salts thereof can be reduced by carrying out contact (Q).

### INDUSTRIAL APPLICABILITY

The aqueous fluoropolymer dispersion of the present invention, which has the constitution described hereinabove, is low in the content of nitrogen-containing organic bases and/or salts thereof and, therefore, are almost odorless and are excellent in workability in processing into tubes, films, molded articles and the like. Furthermore, the aqueous fluoropolymer dispersion can be adjusted to a high fluoropolymer concentration level and a low surfactant content level and therefore is excellent as a material for tubes, films, molded articles, etc.

The method of producing an aqueous fluoropolymer dispersion according to the present invention, which has the constitution described hereinabove, can produce the above-mentioned aqueous fluoropolymer dispersion in a simple and easy manner with high efficiency.

1. An aqueous fluoropolymer dispersion containing a nitrogen-containing organic base and/or a salt thereof, together with a particle of fluoropolymer dispersed therein
wherein said nitrogen-containing organic base and/or the salt thereof amounts, in total, to 0 to 1 ppm of said aqueous fluoropolymer dispersion.

2. An aqueous fluoropolymer dispersion prepared by subjecting a to-be-treated aqueous fluoropolymer dispersion to contact treatment (T1) comprising contact with an anion exchange resin and subsequent contact with active carbon and/or a cation exchange resin, or by subjecting the to-be-treated dispersion to contact treatment (T2) comprising contact with a mixed bed containing an anion exchange resin as well as active carbon and/or a cation exchange resin.

3. The aqueous fluoropolymer dispersion according to claim 2, wherein the aqueous fluoropolymer dispersion contains a nitrogen-containing organic base and/or a salt thereof in a total amount of 0 to 1 ppm of said aqueous fluoropolymer dispersion.

4. The aqueous fluoropolymer dispersion according to claim 1, wherein the nitrogen-containing organic base and/or the salt thereof comprises at least one member selected from the group consisting of amines represented by the formula NR¹R²R³ (in which R¹, R² and R³ are the same or different and each represents a hydrogen atom, an alkyl group or a hydroxyalkyl group; the case where R¹, R² and R³ each is a hydrogen atom being excluded), amine complexes comprising any of said amines, amine-based oniums represented by the formula ⁺NR¹R²R³R⁴ (in which R¹, R², R³ and R⁴ are the same or different and each represents a hydrogen atom, an alkyl group or a hydroxyalkyl group; the case where R¹, R², R³ and R⁴ each is a hydrogen atom being excluded), and amine-based onium compounds comprising any of said amine-based oniums.

5. The aqueous fluoropolymer dispersion according to claim 1, wherein the nitrogen-containing organic base and/or the salt thereof comprises a tertiary amine represented by the formula NR¹¹R¹²R¹³ (in which R¹¹, R¹² and R¹³ are the same or different and each represents an alkyl group of 1 or 2 carbon atoms) and/or a tertiary amine-based oniums represented by the formula ⁺NR¹¹R¹²R¹³R¹⁴ (in which R¹¹, R¹², R¹³ and R¹⁴ are the same or different and each represents a hydrogen atom or an alkyl group of 1 or 2 carbon atoms provided that at least three of R¹¹, R¹², R¹³ and R¹⁴ each is an alkyl group of 1 or 2 carbon atoms).

6. The aqueous fluoropolymer dispersion according to claim 1, wherein the fluorinated surfactant content amounts to 100 ppm or less of a fluoropolymer.

7. The aqueous fluoropolymer dispersion according to claim 1, wherein the particle of fluoropolymer amounts to 20 to 75% by mass of said aqueous fluoropolymer dispersion.

8. A method of producing an aqueous fluoropolymer dispersion which comprises subjecting a to-be-treated aqueous fluoropolymer dispersion comprising a particle of fluoropolymer dispersed therein to contact treatment, said contact treatment comprising contact (P) with an anion exchange resin and contact (Q) with active carbon and/or with a cation exchange resin.

9. The method of producing an aqueous fluoropolymer dispersion according to claim 8, wherein the to-be-treated fluoropolymer dispersion is prepared by polymerization in the presence of a fluorinated surfactant.

10. The method of producing an aqueous fluoropolymer dispersion according to claim 8, wherein the contact treatment comprises a treatment (T1a) comprising contact with an anion exchange resin and subsequent contact with active carbon or a treatment (T2a) comprising contact with a mixed bed containing an anion exchange resin and an active carbon.
